(19) United States
(12) Patent Application Publication
(10) Pub. No.: US 2003/0102414 A1
(43) Pub. Date: Jun. 5, 2003

(54) Collapsible support with arms and legs and methods for using

(76) Inventor: David M. Smart, Maple Valley, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/011,852

(22) Filed: Dec. 4, 2001

(51) Int. Cl. F16M 11/00

(52) U.S. Cl. 248/170; 248/169; 248/163.1; 248/166

(57) ABSTRACT

A collapsible support includes extendable and retractable arms and legs for generating a respective uncollapsed and collapsed state. In the uncollapsed state, the support can be placed on most types of surfaces in an upright position to support a golf club or other items by leaning the item against arms or hanging the item from the arm. In the collapsed state, the arms and legs are substantially parallel and adjacent the support's body and thus easily transported or stored. The support also includes an arm attachment assembly attached to the body and a leg attachment assembly attached to the body, both operable to extend and retract respective arms and legs. Also included is a biasing member to bias the arms and legs in a retracted position, an actuating member to extend the arms and legs, and a locking mechanism to lock the arms and legs in the extended position.

### TECHNICAL FIELD

The present invention relates to supports and more particularly, to a collapsible support with extendable and retractable arms and legs that is easily transported and, when not in use, easily stored.

### BACKGROUND

A collapsible support is useful in a number of activities. For example, in golf one typically carries many clubs when he/she plays a round or when he/she practices his/her swing at a driving range. Stooping over to pick up his/her clubs after each shot—and sometimes before each shot if the golfer desires a different club or the wind changes—can be tiring and throw a golfer out of his/her rhythm. In addition, often times a golfer sets his bag of clubs near the next tee and carries a pitching or sand wedge and a putter to finish the hole. When the golfer carries more than one club like this he must set down the club he does not use for the current shot. This can cause the grips of the club to become wet and force the golfer to dry them. This can also cause the golfer to inadvertently leave the club at the hole after the golfer has finished the hole. With a collapsible support, the golfer can lean unused clubs in an upright position and not stoop to retrieve them, or inadvertently leave a club behind.

Other examples of activities include hunting, target shooting, fishing and the like. With the ability to support a rifle with its lock mechanism off the ground, the lock mechanism is kept clean and the rifle is supported in a safe position—with its barrel pointing to the sky. Similarly, with the ability to support a fishing pole with its reel off the ground, the reel is kept clean.

Although the prior art contains many collapsible supports, the supports typically only provide a collapsible leg, and the few supports that do provide a collapsible arm are typically time consuming to set up. The supports that do provide a collapsible arm typically require a user to loosen a bolt or collar that attaches the legs to the body of the support, move the collar along the body or move the legs to the desired position, and tighten the bolt or collar to retain the legs in the extended position. Then the process is typically repeated to extend the arms. For a golfer, hunter or fisherman such work can be tiring and time consuming and may even be the difference between a successful and unsuccessful hunt.

The conventional supports that do not provide a collapsible arm typically require attachment to the item they support. Unfortunately, attachment to the supported item makes these types of supports time consuming to repeatedly attach to and detach from the item. In addition, these types of supports do not easily allow a user to support different items at the same time. For example, a collapsible support that is attached to a golf bag and supports the bag when the bag is placed on the ground is well known in the art. By forcing a portion of the support up into another portion of the support when the bag is placed on the ground, legs are extended and support the bag in an upright position.

### SUMMARY OF THE INVENTION

The present invention provides a collapsible support having extendable and retractable arms and legs. With the arms and legs extended, the support can be placed on a surface in an upright position for various tools or sporting equipment to hang from or lean against, for example, golf clubs, fishing poles, rifles or hand guns. Thus, a golfer can keep the grips of the clubs he chooses not to use for a shot dry by keeping the grips off the ground. Or, a fisherman can keep his reel clean as he changes bait by leaning his/her pole against the support. Then, when the golfer, fisherman or other user no longer needs the support he/she can quickly and easily retract the arms and legs to a retracted position where the arms and legs are adjacent and parallel to the support body. And thus easily store or carry the collapsible support until he/she needs it.

In one aspect of the invention, the collapsible support includes a body having a longitudinal axis, an arm attachment assembly attached to the body and operable to extend and retract an arm relative to the body, a leg attachment assembly attached to the body and operable to extend and retract a leg relative to the body, and a biasing member linked to the arm and leg and operable to bias the arm and leg in a retracted or extended position. The body includes an inner tube disposed within and movable relative to an outer tube. The leg and arm attachment assemblies include a fixed ring and a moving ring. By attaching the fixed rings to an outer tube of the body and the moving rings to an inner tube of the body, a user can extend or retract the arms and legs simultaneously by moving the inner tube relative to the outer tube.

In addition the body can include a biasing member operable to bias the arm and legs to either an extended position or a retracted position. For example, the biasing member can be spring positioned between the inner and outer tubes.

In another aspect of the invention, the collapsible support includes an actuating member operable to move the arm and leg attachment assemblies to extend or retract the arms and legs. In addition, the actuating member can be operable to retain the arms and legs in either the extended or retracted position. For example, the actuating tube can include a locking mechanism that has a locking pin insertable into a locking portion of an actuating slot in the actuating member or body by turning the actuating member or body.

### BRIEF DESCRIPTION OF THE FIGURES

FIG. 1 is a perspective view of a collapsible support showing arms and legs in an extended position, according to an embodiment of the invention;

FIG. 2 is a perspective view of the collapsible support of FIG. 1 showing arms and legs in a retracted position, according to an embodiment of the invention;

FIG. 3 is a longitudinal cross-sectional view of the collapsible support of FIG. 1 according to an embodiment of the invention;

FIG. 4 is a latitudinal cross-sectional view of the collapsible support of FIGS. 1 and 3 showing a moving arm ring of an arm attachment assembly, according to an embodiment of the invention;

FIG. 5 is a latitudinal cross-sectional view of the collapsible support of FIGS. 1 and 3 showing a fixed leg ring of a leg attachment assembly, according to an embodiment of the invention; and

FIG. 6 is a perspective, close-up view of a lock mechanism shown in FIGS. 1-3, according to an embodiment of the invention.

### DETAILED DESCRIPTION

All terms used herein, including those specifically described below in this section, are used in accordance with their ordinary meanings unless the context or definition indicates otherwise. Also, unless indicated otherwise, except within the claims, the use of “or” includes “and” and vice-versa. Non-limiting terms are not to be construed as limiting unless expressly stated (for example, “including” and “comprising” mean “including without limitation” unless expressly stated otherwise).

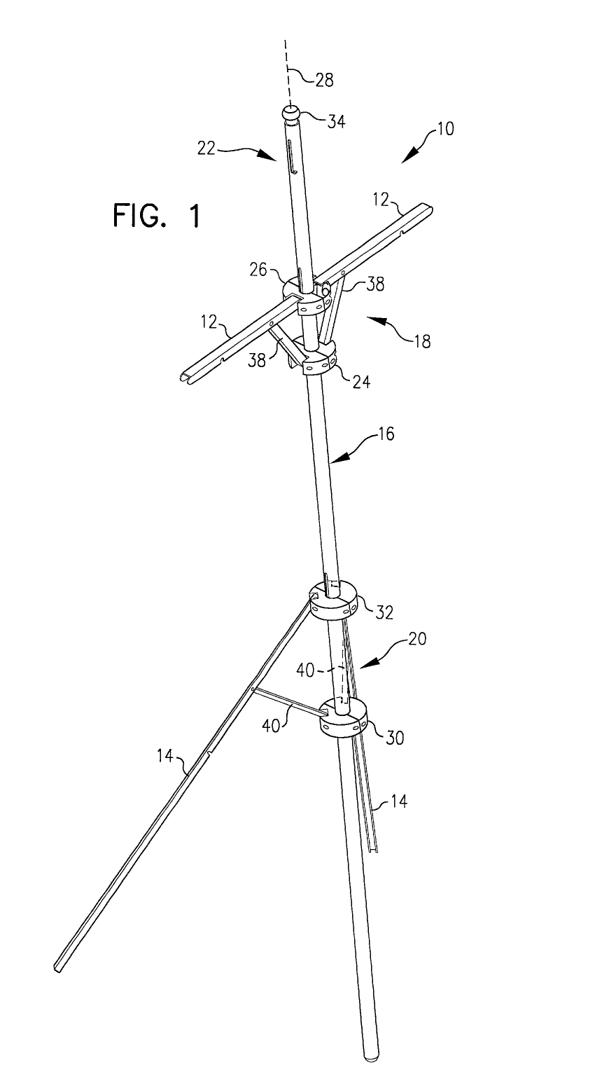

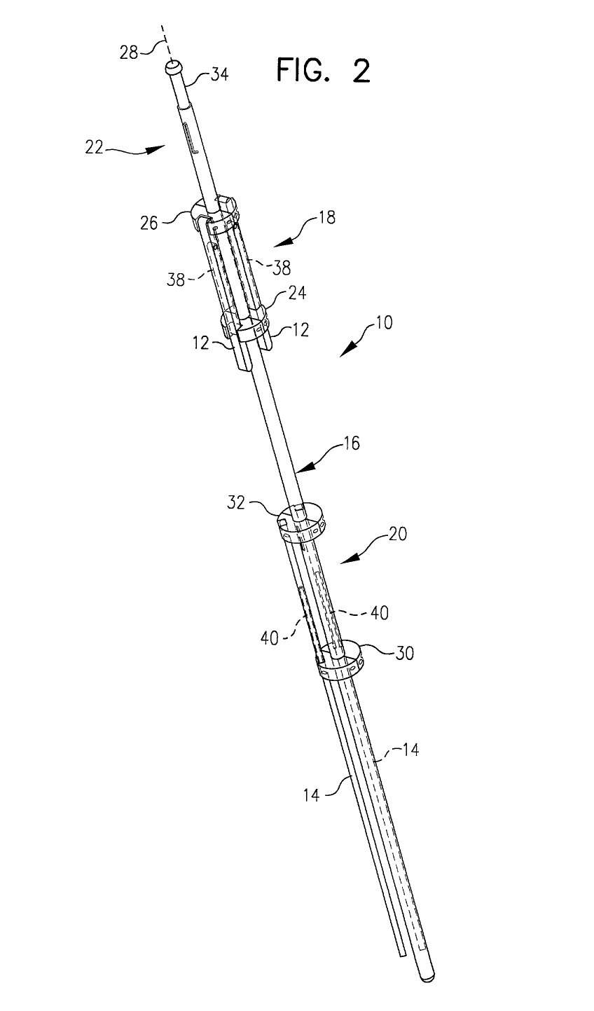

FIGS. 1 and 2 are perspective views of a collapsible support 10 according to an embodiment of the invention. FIG. 1 illustrates the support 10 in an uncollapsed state with two arms 12 and two legs 14 in an extended position. In the uncollapsed state the support 10 can freely stand in an upright position as shown when placed on a surface (not shown) and support various items such as one or more golf clubs, rifles, ball bats, or fishing poles. FIG. 2 illustrates the support 10 in a collapsed state with the arms 12 and legs 14 in a retracted position. In the collapsed state, the support is easily carried or stored until its use is desired.

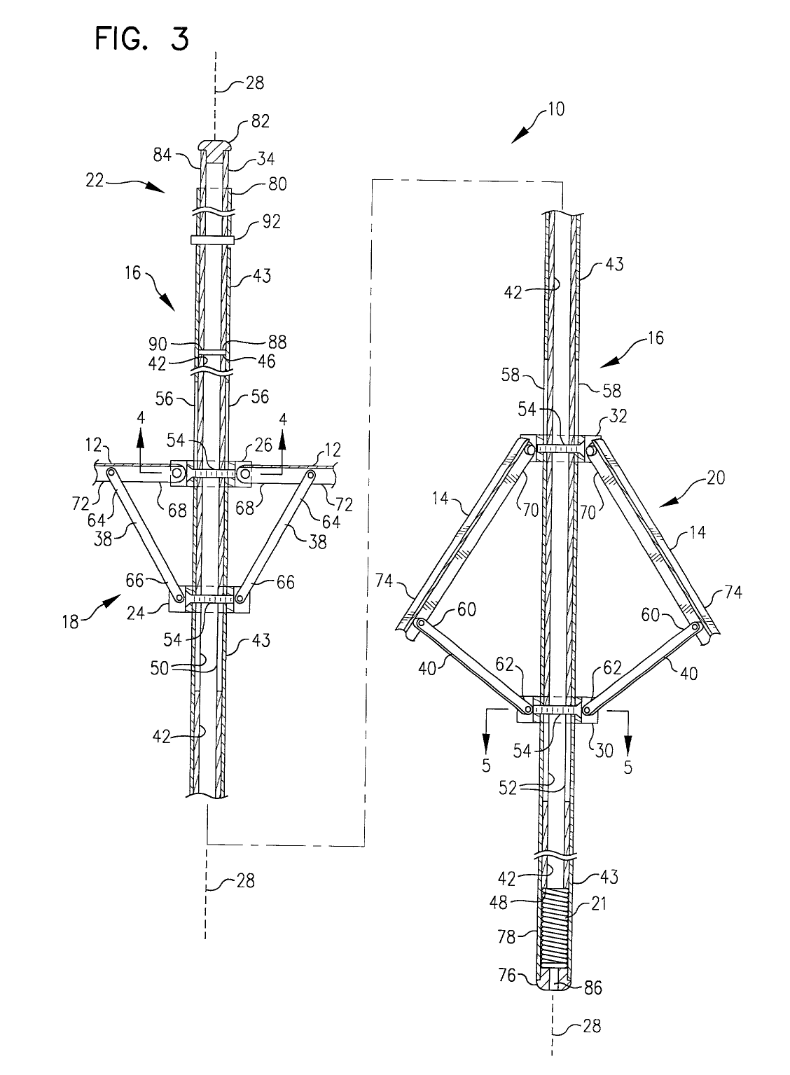

Referring to FIGS. 1 and 2, in this and certain other embodiments, the collapsible support 10 includes a body 16; two arms 12 attached to the body 16 by an arm attachment assembly 18 that is also operable to move the arms 12 to an extended and retracted position; two legs 14 attached to the body 16 by a leg attachment assembly 20 that is also operable to move the legs 14 to an extended and retracted position. The support 10 also includes a biasing member 21 (not shown but discussed in greater detail in conjunction with FIG. 3) that typically biases the arms and legs to the retracted position, an actuating member 34 operable to move the arms and legs 12 and 14 to an extended position, and a lock mechanism 22 operable to retain the arms 12 and legs 14 in an extended position. The arm attachment assembly 18 includes a fixed arm ring 24 attached to the body 16 and a moving arm ring 26 attached to the body 16 and movable relative to the fixed arm ring 24. Likewise, the leg attachment assembly 20 includes a fixed leg ring 30 attached to the body 16 and a moving leg ring 32 attached to the body 16 and movable relative to the fixed leg ring 32.

In this and certain other embodiments, the uncollapsed state includes the arms 12 and legs 14 in a fully extended position, and the collapsed state includes the arm 12 and legs 14 in a retracted position. However, the uncollapsed state can include the arms 12 and legs 14 in more than one extended position as desired. For example, the uncollapsed state can also include the arms 12 and legs 14 extended to a position between the retracted position and the fully extended position. In a fully extended position, the arms 12 typically extend from the moving arm ring 26 in a direction substantially perpendicular to a longitudinal axis 28 of the body 16, and the legs 14 typically extend from the moving leg ring 32 in a direction approximately 35° from the longitudinal axis 28. However, in other embodiments, the legs 14 can extend at an angle more or less than 35°. By varying the legs' angle of extension, the stability of the collapsible support in the upright position can be varied to accommodate items that require more or less force to support. In still other embodiments, the arms 12 can extend at an angle more or less than 90° and the legs 14 can extend at an angle approximately 35°. In yet other embodiments, the arms 12 can extend at an angle more or less than 90° and the legs 14 can extend at an angle more or less than approximately 35°. In a retracted position, the arms 12 and legs 14 typically extend from their respective moving rings 26 and 32 in a direction substantially parallel to the longitudinal axis 28 and adjacent the body 16, but can extend in a direction that is not substantially parallel to the longitudinal axis 28. If more than one extended positions form the uncollapsed state, the arms 12 and legs 14 can respectively extend at angles 45° and 10°, 60° and 20° or any other desired angles from the longitudinal axis 28.

Still referring to FIGS. 1 and 2, in this and certain other embodiments the collapsible support 10 is easily transformed from a collapsed state shown in FIG. 2 to an uncollapsed state shown in FIG. 1. To extend the arms 12 and legs 14, a user pushes the actuating member 34 toward the arm attachment assembly 18. Pushing the actuating member 34 in this direction moves the moving arm and moving leg rings 26 and 32 toward the fixed arm and fixed leg rings 24 and 30 respectively. This in turn causes two arm links 38 to move the arms 12, and two leg links 40 to move the legs 14 to an extended position. Once the arms 12 and legs 14 are in an extended position, the user turns the actuating member 34 relative to the body 16 to prevent the biasing member 21 in FIG. 3 from moving the arms 12 and legs 14 back toward a retracted position. To retract the arms 12 and legs 14—and typically transform the support to a collapsed state—, a user simply turns the actuating member 34 in the opposite direction allowing the biasing member 21 to move the arm and leg rings 26 and 32 away from the fixed arm and leg rings 24 and 30.

Although the collapsible support 10 shown and discussed above includes two arms 12 and two legs 14, the collapsible support 10 can include one arm and one leg or more than two arms 12 and more than two legs 14. Furthermore, although the actuating member 34 is discussed as being pushed by a user to extend the arms 12 and legs 14, the actuating member 34 can be located elsewhere in the collapsible support 10 and include other components for extending or retracting the arms 12 and legs 14. For example, the actuating member can be located at the bottom of the support 10 and can extend the arms 12 and legs 14 by being pushed against the ground. Also, for example, a conventional pneumatic, hydraulic or electrical actuator or motor connected to a respective pneumatic, hydraulic or electrical system that powers the actuator or motor can move the actuating member to extend or retract the arms 12 and legs 14.

FIG. 3 is a cross-sectional view of the collapsible support 10 of FIG. 1 showing an inner tube 42, an outer tube 43 and a biasing member, typically a spring 21. In this and certain other embodiments, the body 16 includes an inner tube 42 disposed within an outer tube 43, and having an actuating end 46 and a spring end 48. The spring 21 is disposed within the outer tube 43 and contacts the spring end 48.

In this and certain other embodiments, the inner tube 42 is a cylindrical tube having a substantially circular radial cross section, and includes two opposing inner-tube arm slots 50 and two opposing inner-tube leg slots 52, that are sized to permit movement of the inner tube 42 relative to the ring attachment fasteners 54 as the inner tube 42 moves relative to the outer tube 43. The inner tube 42 is made of any conventional material such as plastic, metal or rubber capable of withstanding compressive loads generated by the spring 21 and a user during extension and retraction of the arms 12 and legs 14, and capable of resisting substantial wear from sliding contact with portions of the outer tube 43 and with the ring attachment fasteners 54. In other embodiments, the material can be less wear resistant and the inner tube 42 can include wear plates attached to portions of the inner tube that typically encounter substantial wear. Also, the inner tube 42 can protrude from the outer tube 43 to provide a user-accessible portion for the user to push to extend and retract the arms 12 and legs 14. In addition, although the arm and leg slots 50 and 52 are substantially straight, the slots 50 and 52 can include a locking portion that is similar to the locking portion of the lock mechanism 22 described in greater detail elsewhere herein. Also, the inner tube 42 can include none, one or more than two slots 50 and 52 as desired or dictated by the attachment of the fixed arm and leg rings 24 and 30 to the outer tube 43.

Still referring to FIG. 3, in this and certain other embodiments the outer tube 43 is a cylindrical tube having a substantially circular radial cross section, and includes two opposing outer-tube arm slots 56 and two opposing outer-tube leg slots 58, that are sized to permit movement of the ring attachment fasteners 54 as the inner tube 42 moves relative to the outer tube 43. The outer tube 43 is made of any conventional material such as plastic, metal or rubber capable of resisting substantial wear from sliding contact with portions of the inner tube 42 and with the ring attachment fasteners 54. In other embodiments, the material can be less wear resistant and the outer tube 43 can include wear plates attached to portions of the outer tube 43 that typically encounter substantial wear. In addition, although the outer-tube arm and leg slots 56 and 58 are substantially straight, the slots 56 and 58 can include a locking portion similar to the locking portion of the lock mechanism 22 described in greater detail elsewhere herein. In addition, if the inner tube also includes locking portions as previously discussed then the locking portions of the outer tube 43 should be located to correspond with the locking portions of the inner tube 42 such that as the inner tube 42 is rotated the attachment fasteners 54 are inserted into their respective locking portions.

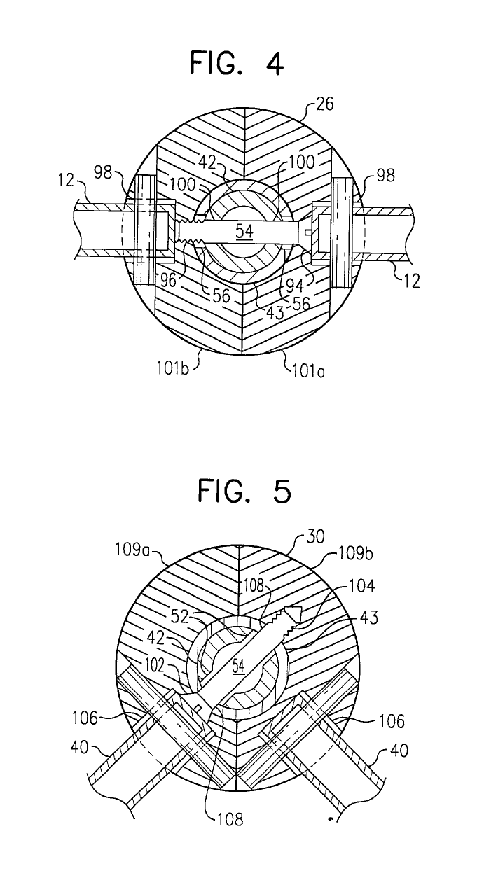

Still referring to FIG. 3, the leg attachment assembly 20 attaches the legs 14 to the body 16 of the collapsible support 10, and operates to extend and retract the legs 14 as desired. In this and certain other embodiments, the leg attachment assembly 20 includes the moving leg ring 32 attached to the inner tube 42, the fixed leg ring 30 attached to the outer tube 43, and leg links 40 each having a leg end 60 pivotally attached to the leg 14 and a ring end 62 pivotally attached to the fixed leg ring 30. As discussed in greater detail in conjunction with FIGS. 4 and 5, the fasteners 54 securely attach the moving leg ring 32 to the inner tube 42 and attach the fixed leg ring 30 to the outer tube 43. The leg links 40 are pivotally attached to the fixed leg ring 30 and legs 14 by conventional techniques such as bushings, bearings and bolts, or pins to allow rotational movement relative to the fixed leg ring 30 and leg 14 as the moving leg ring 32 moves toward or away from the fixed leg ring 30 to extend or retract, respectively, the leg 14. By increasing the length of the leg links 40, a user can increase the leg's angle of extension and by decreasing the length of the leg links 40 a user can decrease the leg's angle of extension. Thus, the stability of the collapsible support 10 in the upright position can be varied to accommodate various items having different weights and leaned against the arms 12 or hung from the arms 12.

Still referring to FIG. 3, the arm attachment assembly 18 attaches the arms 12 to the body 16 of the collapsible support 10, and operates to extend and retract the arms 12 as desired. In this and certain other embodiments, the arm attachment assembly 18 includes the moving arm ring 26 attached to the inner tube 42, the fixed arm ring 24 attached to the outer tube 43, and arm links 38 each having an arm end 64 pivotally attached to one of the arms 12 and a ring end 66 pivotally attached to the fixed arm ring 24. As discussed in greater detail in conjunction with FIGS. 4 and 5, the fasteners 54 securely attach the moving arm ring 26 to the inner tube 42 and the fixed arm ring 24 to the outer tube 43. The arm links 38 are pivotally attached to the fixed arm ring 24 and arms 12 by conventional techniques such as bushings, bearings and bolts, or pins to allow rotational movement relative to the fixed arm ring 24 and arms 12 as the moving arm ring 26 moves toward or away from the fixed arm ring 24 to extend or retract, respectively, the arms 12. By increasing the length of the arm links 38, a user can increase the arm's angle of extension and by decreasing the length of the arm links 38 a user can decrease the arm's angle of extension to support various items with different shapes like golf clubs, tennis racquets, rifles, lumber or any other desired item.

Still referring to FIG. 3, in this and certain other embodiments, each arm 12 and leg 14 includes respective attachment ends 68 and 70 pivotally attached to their respective moving arm and moving leg rings 26 and 32, and a respective arm and leg body 72 and 74. Conventional techniques such as bushings, bearings and bolts, or pins pivotally attach the arm and leg attachment ends 68 and 70 to their respective arm and leg moving rings 26 and 32. The arm end 64 of the arm link 38 and the leg end 60 of the leg link 40 are attached, as previously discussed, to the arm body 72 and leg body 74 of their respective arms and legs 12 and 14. By attaching the arm links 38 and leg links 40 closer to or farther from their respective arm and leg attachment ends 68 and 70, the arm and leg's angle of extension can be increased or decreased as desired. Consequently, in some embodiments the arm or leg bodies 72 and 74 can include multiple locations where the arm and leg attachment ends 64 and 60 of the arm and leg links 38 and 40 can be removably and pivotally attached to their respective arms and legs 12 and 14. The arms and legs 12 and 14 can be made of any material desired and are each typically formed from channel stock but each can also be formed from circular or square bar stock or other types of stock or can be formed into any desired geometric shape. In addition, although the arms 12 and legs 14 are shown substantially straight, the arms 12 and legs 14 can be curved as desired.

Still referring to FIG. 3, the body 16 of the collapsible support 10 also includes a spring 21 for biasing the collapsible support 10 to the collapsed state and an actuating tube 34 for extending the arms and legs 12 and 14 of the support 10. In this and certain other embodiments, the spring 21 is typically located at the bottom 78 of the outer tube 43 and compressed between the spring end 48 of the inner tube 42 and an outer-tube cap 76 attached to the bottom 78 of the outer tube 43. However, in other embodiments the spring 21 can be located at any desirable position that permits the spring 21 to bias the arms 12 and legs 14 in the retracted position. For example, the spring 21 can be compressed between the top 80 of the outer tube 43 and an actuating-tube cap 82 attached to the top end 84 of the actuating member 34, or one spring can be compressed between the fixed and moving leg rings 30 and 32 while another similar spring can be compressed between the fixed and moving arm rings 24 and 26. The spring 21 is typically a conventional coil spring designed as desired to provide a force against the inner tube 42 without binding in the outer tube 43 as it is compressed, and is made of any conventional resilient material. However, the spring 21 can include elastic straps or cords or any desired element capable of biasing the arms 12 and legs 14 to the retracted position.

The outer-tube cap 76 is typically formed to provide a protective skid surface for the bottom 78 of the outer tube 43 and a drain hole 86 to allow undesirable fluids or gasses to escape from inside the outer tube 43, and made of any conventional material such as plastic, metal or rubber. The outer-tube cap 76 is typically frictionally attached to the outer tube 43 by inserting a portion of the outer-tube cap 76 having a diameter slightly greater than the inside diameter of the outer tube 43. However, in other embodiments the outer-tube cap 76 can be attached by conventional fastening techniques such as applying an adhesive or using conventional mechanical fasteners such as screws or bolts and nuts.

Still referring to FIG. 3, in this and certain other embodiments, the actuating member 34 includes a top end 84 protruding from the top 80 of the outer tube 43 and a contact end 88 that transmits the longitudinal motion of the actuating member 34 to the inner tube 42 through the washer 90. In this and certain other embodiments, the actuating member 34 is a cylindrical tube having a substantially circular radial cross section and made of any conventional material such as plastic, metal or rubber capable of withstanding compressive loads generated by the spring 21 and a user during extension and retraction of the arms 12 and legs 14 and capable of resisting substantial wear from sliding contact with portions of the outer tube 43 and with the washer 90. In other embodiments, the material can be less wear resistant and the actuating member 34 can include wear plates attached to portions of the actuating member 34 that typically encounter substantial wear. Attached to the top end 84, the actuating-member cap 82 is typically formed to provide a comfortable grip for a user's hand as the user pushes the actuating member 34 and made of any desired material such as plastic, metal or rubber. The actuating-member cap 82 is typically frictionally attached to the actuating member 43 by inserting a portion of the actuating-member cap 82 having a diameter slightly greater than the inside diameter of the actuating member 34. However, in other embodiments the actuating-member cap 82 can be attached by conventional fastening techniques such as applying an adhesive or using conventional fasteners such as screws or bolts and nuts. In another embodiment, the cap 82 can be formed to provide an umbrella-type handle and slip fit over the top end 84. Disposed between the contact end 88 of the actuating member 34 and the actuating end 46 of the inner tube 42, the washer 90 allows a user to rotate the actuating member 34 to lock the support 10 without rotating the inner tube 42. Consequently, the washer 90 is made of any conventional material that provides minimal friction between the contact end 88 and the washer 90, and the actuating end 46 and the washer 90, but can be made of any desired material with any conventional anti-friction coating.

Still referring to FIG. 3, in this and certain other embodiments the locking mechanism 22 includes a lock pin 92 attached to the actuating member 34. The lock pin 92 typically passes through the actuating member 34 and extends through two diametrically opposed, actuating slots in the outer tube 43 as discussed in greater detail in conjunction with FIG. 5. The lock pin 92 is typically press fit through the actuating member 34 to keep the pin 92 from sliding out of the actuating member 34, but the pin 92 can be attached to the actuating member 34 in any desired manner that prevents the pin 92 from dislodging during repeated extension and retraction of the arms 12 and legs 14 or prolonged extension of the arms 12 and legs 14.

FIG. 4 is a cross sectional view of the collapsible support 10 of FIGS. 1 and 3 taken at section line 4-4 shown in FIG. 3 according to an embodiment of the invention.

FIG. 4 illustrates one embodiment of the moving arm ring 26 attached to the body 16 in FIGS. 1-3. The attachment of the moving leg ring 32 in FIGS. 1-3 to the body 16 is similar to the attachment of the moving arm ring 26 shown in FIG. 4 except as discussed below.

In this and certain other embodiments, the moving arm ring 26 includes a first hole 94 into which the attachment fastener 54 is inserted, a second hole 96 that threadingly receives the attachment fastener 54, and two arm attachment portions 98 to which respective arms 12 are attached. Inserted through the first hole 94 in the moving arm ring 26 and two diametrically opposed holes 100 in the inner tube 42, the attachment fastener 54 threadingly engages the second hole 96 in the moving arm ring 26 and thereby attaches the moving arm ring 26 to the inner tube 42. The attachment fastener 54 is also inserted through the two outer-tube slots 56 in the outer tube 43 that are sized to permit the attachment fastener 54 to move along the longitudinal axis 28 of FIGS. 1-3—into and out of the cross-sectional plane. After passing through the inner and outer tubes 42 and 43, the attachment fastener 54 is turned to force the two halves 101a and 101b of the moving arm ring 26 together. In other embodiments, other conventional fastening techniques such as press fitting a pin into the inner tube 42 and moving arm ring 26, riveting, or other desired techniques can be used to attach the moving arm ring 26 to the inner tube 42. To allow the moving arm ring 26 to move relative to the outer tube 28 as the inner tube 42 moves along the longitudinal axis 28, the two halves 101a and 101b contact each other and prevent the halves 101a and 101b from clamping down on the outer tube 43. When the inner tube 42 moves relative to the outer tube 43, the attachment fastener 54 transmits this movement to the moving arm ring 26 that also moves relative to the outer tube 43. Consequently, the moving arm ring 26 moves relative to the fixed arm ring 24 in FIGS. 1-3 and depending on the direction of the movement either extends or retracts the arms 12.

Still referring to FIG. 4 in this and certain other embodiments, the arm attachment portions 98 are approximately diametrically opposite each other when the moving arm ring 26 is attached to the body 16 of the support 10. Thus, the arms 12 are approximately 180° apart as measured from a central longitudinal axis (not shown) that is or approximately is collinear with longitudinal axis 28 in FIGS. 1-3 when the moving arm ring 26 is attached to the body 16. In other embodiments, the arm attachment portions 26 can be located other angles apart from each other as measured from the central longitudinal axis such as 120° or any other desired angle.

Still referring to FIG. 4, in this and certain other embodiments the moving leg ring 26 is similarly attached to the inner tube 42. However, because the legs 14 are used to stand the collapsible support 10 in an upright position when they are extended, the respective leg attachment portions typically are not diametrically opposite each other. Instead, the leg attachment portions are typically 90° apart as measured from the longitudinal axis 28. In other embodiments, the leg attachment portions can be located other angles apart from each other such as 100°, 75°, or any other desired angle.

FIG. 5, is a cross sectional view of the collapsible support 10 of FIGS. 1 and 3 taken at section line 5-5 shown in FIG. 3 according to an embodiment of the invention. FIG. 5 illustrates one embodiment of the fixed leg ring 30 attached to the body 16 in FIGS. 1-3. The attachment of the fixed arm ring 24 in FIGS. 1-3 to the body 16 is similar to the attachment shown in FIG. 5 except as discussed below.

In this and certain other embodiments, the fixed leg ring 30 includes a first hole 102 into which the attachment fastener 54 is inserted, a second hole 104 that threadingly receives the attachment fastener 54, and two leg-link-attachment portions 106 to which respective leg links 40 are attached. Inserted through a first hole 102 in the fixed leg ring 30 and two diametrically opposed holes 108 in the outer tube 43, the ring attachment fastener 54 threadingly engages the second hole 104 in the fixed leg ring 30 and thereby attaches the fixed leg ring 30 to the outer tube 43. The attachment fastener 54 is also inserted through the two inner-tube slots 52 in the inner tube 42 that are sized to permit movement of the attachment fastener 54 along the longitudinal axis 28 in FIGS. 1-3—into and out of the cross-sectional plane. After passing through the inner and outer tubes 42 and 43, the attachment fastener 54 is turned to force the two halves 109a and 109b of the fixed leg ring 30 together. In other embodiments, other conventional fastening techniques such as press fitting a pin into the outer tube 43 and fixed leg ring 30, riveting, welding or other techniques as desired can be used to attach the fixed leg ring 30 to the outer tube 43. When the inner tube 42 moves relative to the outer tube 43, the inner tube slots 52 permit the inner tube 42 to move relative to the attachment fastener 54 to allow the fixed leg ring 30 to remain stationary relative to the outer tube 43. Consequently, the moving leg ring 32 in FIGS. 1-3 moves toward or away from the fixed leg ring 30 and either extends or retracts the legs.

Still referring to FIG. 5 in this and certain other embodiments, the leg-link-attachment portions 106 are approximately 90° apart from each other when the fixed leg ring 30 is attached to the body 16. Thus, the legs 14 are approximately 90° apart as measured from a central longitudinal axis (not shown) that is or approximately is collinear with the longitudinal axis 28 of FIGS. 1-3 when the fixed leg ring 26 is attached to the body 16. In other embodiments, the leg-link-attachment portions 106 can be located other angles apart from each other as measured from the central longitudinal axis, such as 100°, 75°, or any other desired angle.

Still referring to FIG. 5, in this and certain other embodiments the fixed arm ring 24 is similarly attached to the outer tube 43. However, because the arms 12 are not used to stand the collapsible support 10 in an upright position when they are extended the respective arm-link-attachment portions can be located any desired angle apart from each other as measured from the longitudinal axis 28. Typically, the arm-link-attachment portions are diametrically opposite each other.

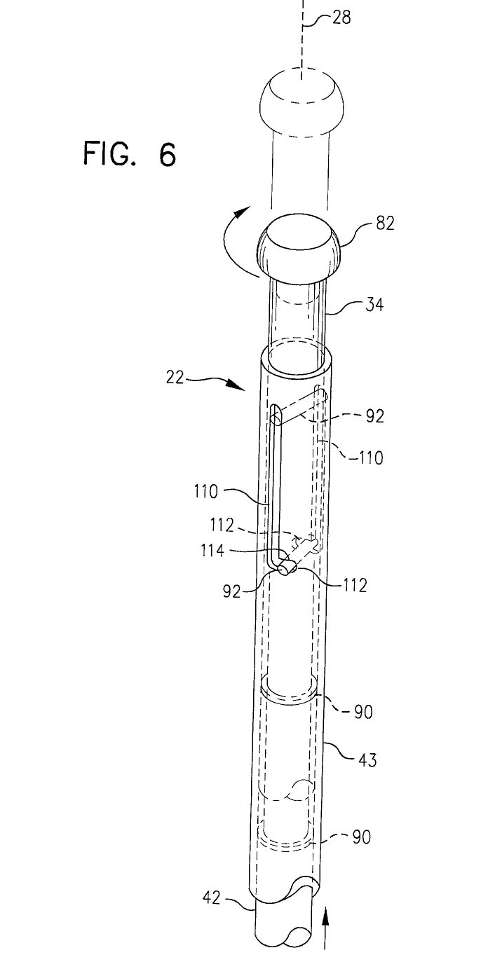

FIG. 6 is a perspective view of the lock mechanism 22 of FIGS. 1-3 according to an embodiment of the invention. In this and certain other embodiments and as previously discussed, the lock mechanism 22 includes the lock pin 92 attached to the actuating member 34 but also includes two actuating slots 110 in the outer tube 43 that have a lock portion 112. The two diametrically opposed actuating slots 110 are sized to permit the movement of the lock pin 92 as the actuating member 34 moves relative to the outer tube 43. In addition, the actuating slot 110 is typically oriented on the outer tube 43 to permit substantial movement of the lock pin 92 in the direction of the longitudinal axis 28. Whereas, the lock portion 112 is typically oriented on the outer tube 43 to prevent substantial movement of the lock pin 92 in the direction of the longitudinal axis 28. In some embodiments, the lock portion 112 can include a notch or enlarged end into which the lock pin 92 can be inserted that helps prevent the lock pin 92 from easily leaving the lock portion 112. To lock the arms 12 and legs 14 (not shown) in the extended position, a user inserts the lock pin 92 into the lock portion 112 of the actuating slot 110 by turning the actuating member 34. Once inserted, the pin 92 contacts the slot edge 114 and prevents the spring 21 in FIG. 3 from moving the lock pin 92 back up the actuating slot 110.

In other embodiments of the lock mechanism 22, the outer tube 43 can include one or more than two actuating slots with corresponding lock pins. Furthermore, other embodiments of the lock mechanism can include one or more actuating slots oriented in any desired manner. For example, the actuating slot could form a helix on the outer tube 43 and force the lock pin 92 to travel a helical path, and thus, the actuating member 34 to rotate as the actuating member 34 moves toward the arm attachment assembly 18. In addition, other embodiments of the actuating slot can include multiple lock portions located at different longitudinal positions along the actuating slot for retaining the arms 12 and legs 14 in more than one extended position.

Although the collapsible support has been described in considerable detail with reference to certain embodiments for purposes of illustration, other embodiments are possible. Therefore the spirit and scope of the appended claims should not be limited to the above description of the embodiments; the present invention includes suitable modifications as well as all permutations and combinations of the subject matter set forth herein.

What is claimed is

1. An extendable and retractable support comprising:
a body including a longitudinal axis;
an arm attached to the body and extendable to an extended position;
a leg attached to the body and extendable to an extended position; and
a biasing member linked to the arm and leg and operable to simultaneously move the arm and leg.

2. The support of claim 1 further comprising a locking mechanism operable to retain the arm and leg in the extended position.

3. The support of claim 1 further comprising an actuating member attached to the body and operable to move the arm and the leg.

4. The support of claim 1 wherein the arm and leg are retractable to a retracted position.

5. The support of claim 4 wherein the retracted position includes the legs positioned substantially parallel to the longitudinal axis.

6. The support of claim 4 wherein the retracted position includes the arms and the legs positioned substantially parallel to the longitudinal axis.

7. The support of claim 1 wherein the extended position includes the leg positioned at a non-zero angle less than 90° to the longitudinal axis.

8. The support of claim 1 wherein the extended position includes the arm positioned perpendicular or substantially perpendicular to the longitudinal axis and the leg positioned at a non-zero angle less than 90° to the longitudinal axis.

9. The support of claim 1 further comprising a leg attachment assembly operable to move a plurality of legs.

10. The support of claim 1 further comprising an arm attachment assembly operable to move a plurality of arms and a leg attachment assembly operable to move a plurality legs.

11. The support of claim 4 wherein the biasing member is operable to bias the arm and leg to the retracted position.

12. An extendable and retractable support comprising:
a body having a longitudinal axis and including an outer tube having a top and an inner tube disposed within the outer tube and moveable within the outer tube;
an arm attachment assembly including a fixed arm ring attached to the outer tube and a moving arm ring attached to the inner tube and moveable relative to the outer tube wherein the arm attachment assembly is operable to move an arm to an extended position as the inner tube moves;
a leg attachment assembly including a fixed leg ring attached to the outer tube and a moving leg ring attached to the inner tube and moveable relative to the outer tube, wherein the leg attachment assembly is operable to move a leg to an extended position as the inner tube moves; and
a lock mechanism operable to retain the arm and leg in the extended position.

13. The support of claim 12 wherein:
the arm attachment assembly is operable to move the arm to a retracted position as the inner tube moves, and
the leg attachment assembly is operable to move the leg to a retracted position as the inner tube moves.

14. The support of claim 12 wherein the arm includes a straight or substantially straight arm body.

15. The support of claim 12 wherein the leg includes a straight or substantially straight leg body.

16. The support of claim 12 wherein the moving leg ring surrounds a portion of the outer tube.

17. The support of claim 12 wherein the moving leg ring and the moving arm ring surround different portions of the outer tube.

18. The support of claim 12 wherein:
the arm attachment assembly and the leg attachment assembly are operable to simultaneously move their respective arm and leg to a retracted position as the inner tube moves, and
the body includes a bias member disposed between the inner tube and the outer tube that is operable to bias the arm and leg to the retracted position.

19. The support of claim 12 wherein the lock mechanism includes:
an actuating tube operable to move the inner tube,
a locking portion in an actuating slot formed in the outer tube, and
a lock pin attached to the actuating tube and extending into the actuating slot,
wherein the actuating slot is oriented on the outer tube such that the pin moves within the slot as the actuating tube moves along the longitudinal axis relative to the outer tube and the lock pin contacts a slot edge to retain the arm and leg in an extended position.

20. An arm attachment assembly comprising:
a moving arm ring including a central longitudinal axis and an arm attachment portion, wherein the ring is attachable to an inner tube and an arm is pivotally attachable to the arm attachment portion;
a fixed arm ring attachable to an outer tube and having an arm-link-attachment portion;
an arm link having an arm end pivotally attachable to an arm and a ring end pivotally attachable to the fixed arm ring.

21. The arm attachment assembly of claim 20 further comprising an arm that includes an attachment end pivotally attached to the moving arm ring and an arm body pivotally attached to the arm end of the arm link.

22. The arm attachment assembly of claim 20 wherein the moving arm ring is pivotally attachable to two arms.

23. The arm attachment assembly of claim 20 further comprising a second arm link having an arm end pivotally attachable to a second arm and a ring end pivotally attachable to the fixed arm ring and wherein the moving arm ring is pivotally attachable to two arms.

24. The arm attachment assembly of claim 20 wherein the moving arm ring includes two arm attachment portions spaced or approximately spaced 180 degrees apart as measured from the central longitudinal axis.

25. A leg attachment assembly comprising:
a moving leg ring including a central longitudinal axis and an leg attachment portion, wherein the ring is attachable to an inner tube and a leg is pivotally attachable to the leg attachment portion;
a fixed leg ring attachable to an outer tube and having a leg-link-attachment portion;
a leg link having a leg end pivotally attachable to a leg and a ring end pivotally attachable to the fixed leg ring.

26. The leg attachment assembly of claim 25 further comprising a leg that includes an attachment end pivotally attached to the moving leg ring and a leg body pivotally attached to the leg end of the leg link.

27. The leg attachment assembly of claim 25 wherein the moving leg ring is pivotally attachable to two legs.

28. The leg attachment assembly of claim 25 further comprising a second leg link having leg end pivotally attachable to a second leg and a ring end pivotally attachable to the fixed leg ring and wherein the moving leg ring is pivotally attachable to two legs.

29. The leg assembly of claim 25 wherein the moving leg ring includes two leg attachment portions spaced or approximately spaced 90 degrees apart as measured from the central longitudinal axis.

30. A method for support comprising:
moving an arm attachment assembly attached to a body and a leg attachment assembly attached to the body wherein an arm and a leg are moved to an extended position;
locking the arm and leg in the extended position; and
placing the leg and body on a surface such that the arm is suspended above the surface.

31. The method of claim 30 further comprising moving the arm attachment assembly and the leg attachment assembly wherein an arm and leg are moved to a retracted position.

32. The method of claim 30 wherein the moving an arm attachment assembly and leg attachment assembly includes moving a moving arm ring and a moving leg ring toward a respective fixed arm ring and fixed leg ring.

33. The method of claim 30 wherein moving the arm and leg attachment assemblies includes pushing an actuating member.

34. The method of claim 30 wherein locking the arm and leg in an extended position includes rotating an actuating member relative to the body.
